(19) United States
(12) Patent Application Publication
(10) Pub. No.: US 2010/0166133 A1
(43) Pub. Date: Jul. 1, 2010

(54) USE OF ISOTOPICALLY ENRICHED NITROGEN IN ACTINIDE FUEL IN NUCLEAR REACTORS

(76) Inventors: Edward J. Lahoda, Pittsburgh, PA (US); Jeffrey A. Brown, Ellington, CT (US); Satya R. Pati, Simsbury, CT (US); Lars G. Hallstadius, Vasteras (SE); Robert P. Harris, Bloomfield, CT (US); Bojan Petrovic, Monroeville, PA (US)

Correspondence Address: WESTINGHOUSE ELECTRIC COMPANY, LLC, P.O. BOX 355, PITTSBURGH, PA, 15230-0355, US

(21) Appl. No.: 11/760,179

(22) Filed: Jun. 8, 2007

Related U.S. Application Data
(63) Continuation-in-part of application No. 10/879,416, filed on Jun. 29, 2004, now abandoned.

(51) Int. Cl. C01G 56/00; G21C 1/08; G21C 3/00; G21C 1/07; G21C 15/00; C01F 15/00; C01G 43/00

(52) U.S. Cl. 376/171; 376/419; 376/381; 376/370; 423/254; 423/252; 423/251

(57) ABSTRACT

The present invention provides a nuclear fuel comprising an actinide nitride such as ²³³U, ²³⁴U, ²³⁵U, ²³⁶U, ²³⁸U, ²³²Th, ²³⁹Pu, ²⁴⁰Pu, ²⁴¹Pu, ²⁴²Pu, ²⁴⁴Pu, ²³⁹Np, ²³⁹Am, ²⁴⁰Am, ²⁴¹Am, ²⁴²Am, ²⁴³Am, ²⁴⁴Am, ²⁴⁵Am, ²⁴⁰Cm, ²⁴¹Cm, ²⁴²Cm, ²⁴³Cm, ²⁴⁴Cm, ²⁴⁵Cm, ²⁴⁶Cm, ²⁴⁷Cm, ²⁴⁸Cm, ²⁴⁹Cm, ²⁵⁹Cm, ²⁴⁵Bk, ²⁴⁶Bk, ²⁴⁷Bk, ²⁴⁸Bk, ²⁴⁹Bk, ²⁵⁰Bk, ²⁴⁸Cf, ²⁴⁹Cf, ²⁵⁰Cf, ²⁵¹Cf, ²⁵²Cf, ²⁵³Cf, ²⁵⁴Cf, ²⁵⁵Cf, ²⁴⁹Es, ²⁵⁰Es, ²⁵¹Es, ²⁵²Es, ²⁵³Es, ²⁵⁴Es, ²⁵⁵Es, ²⁵¹Fm, ²⁵²Fm, ²⁵³Fm, ²⁵⁴Fm, ²⁵⁵Fm, ²⁵⁶Fm, ²⁵⁷Fm, ²⁵⁵Md, ²⁵⁶Md, ²⁵⁷Md, ²⁵⁸Md, ²⁵⁹Md, ²⁶⁰Md, ²⁵³No, ²⁵⁴No, ²⁵⁵No, ²⁵⁶No, ²⁵⁷No, ²⁵⁸No and ²⁵⁹No, and optionally fission products such as ⁹⁷Tc, ⁹⁸Tc and ⁹⁹Tc, suitable for use in nuclear reactors, including those based substantially on thermal fission, such as light and heavy water reactors, gas-cooled nuclear reactors, liquid metal fast breeders or molten salt fast breeders. The fuel contains nitrogen which has been isotopically enriched to at least about 50% ¹⁵N, most preferably above 95%.

This application is a continuation-in-part of U.S. application Ser. No. 10/879,416, filed Jun. 29, 2004, which is incorporated herein by reference.

### BACKGROUND OF THE INVENTION

1. Field of the Invention

The present invention relates to the field of nuclear fuels for nuclear power plants. Specifically, a fuel comprising an actinide nitride, suitable for use in nuclear reactors, including those based substantially on thermal fission, such as light and heavy water reactors, gas-cooled nuclear reactors, liquid metal fast breeders or molten salt fast breeders, is provided. The fuel contains nitrogen which has been isotopically enriched to at least 50% ¹⁵N.

2. Description of Related Art

In a typical nuclear reactor, such as a pressurized water reactor (PWR), a heavy water reactor (HWR) or a boiling water reactor (BWR), the reactor core includes a large number of fuel assemblies, each of which is composed of a plurality of elongated fuel elements or rods. The fuel rods each contain fissile material such as uranium oxide (UO₂), usually in the form of a stack of nuclear fuel pellets, although annular or particle forms of fuel are also used. The fuel rods are grouped together in an array which is organized to provide a neutron flux in the core sufficient to support a high rate of nuclear fission and thus the release of a large amount of energy in the form of heat. A coolant, such as water or gas, is pumped through the core in order to extract some of the heat generated in the core for the production of useful work.

First generation nuclear reactors were reactors built to prove that nuclear energy could work in the laboratory as well as on the chalkboard. Second generation reactors, such as the PWR or BWR described above, took the technology one step further, demonstrating that the machines were economically feasible power plants. Most nuclear power plants in operation in the United States today are second generation plants. Emerging, third generation reactors are equipped with advanced features, such as safety systems incorporating passive energy dissipation or natural processes, simplifying their design and allowing them to cope with malfunctions without the need for complex auxiliary safety systems. While most second generation plants operate at very competitive power production cost rates, third generation plants have been designed that have increased capacity, a lower cost of generating electricity due to an increased output/investment ratio, and are cost-competitive to build.

Various methods are available to increase power production, some more desirable than others. Increasing the fuel utilization in a plant by shortening the fuel cycle is a widely recognized method, but shorter fuel cycles often result in higher production costs and more spent fuel waste discharge. Initiatives to decrease the rate of spent fuel production by increasing the discharge burnup is limited by fuel rod clad corrosion as well as by limits on fuel enrichment imposed by spent fuel pool considerations and fuel production plant limitations.

Another method to improve power production is the use of annular fuel. Annular fuel provides an increase in the surface area to volume ratio of over 50% as compared with solid-pellet fuel, and a corresponding increase in the volumetric heat flux or power density in the reactor. Unfortunately, this results in a shorter fuel cycle, due to the very high rate of usage and the fact that there is somewhat less uranium in the core than when solid pellets are used. Even with the use of longer fuel rods and reflectors to increase fuel efficiency, the fuel cycle falls short of the desired interval.

Fuel costs can be decreased by increasing the amount of uranium contained in each fuel rod. A sizeable increase in the uranium loading allows the number of assemblies loaded (and consequently the number discharged) to be decreased, thus decreasing the volume of discharged spent fuel. In addition, the higher loading results in lower ²³⁵U enrichment requirements, which results in better fuel utilization and lower fuel cycle costs. Decreasing the enrichment saves money because the cost of enriched fuel increases non-linearly with enrichment. That is, increasing the enrichment from 4% to 5% increases the cost for the uranium by more than 25%. Finally, a substantial increase in the uranium loading in each fuel rod facilitates the implementation of longer fuel cycles (improving capacity) or an increase in the power level of existing plants, thereby providing new electricity at minimal expense.

For new plants as well as those currently operating, it is desirable to increase the utilization of nuclear fuel and decrease the volume of spent fuel produced by these plants.

There exists a need, therefore, to provide an economical fuel for use in nuclear reactors that has the added benefit of reducing the volume of spent fuel discharged in the nuclear reactors.

### SUMMARY OF THE INVENTION

The present invention meets this need by providing a cost-effective nuclear fuel for use in fission-based nuclear reactors.

In an aspect of the present invention, the nuclear fuel comprises an actinide nitride for use in a light water reactor, heavy water reactor or a high temperature gas cooled reactor such as a pebble bed modular reactor, comprising a naturally occurring actinide or a synthetic element, the synthetic element having an atomic number greater than 92 or an atomic weight of 231 or greater, the actinide nitride selected from ²³³U, ²³⁴U, ²³⁵U, ²³⁶U, ²³⁸U, ²³²Th, ²³⁹Pu, ²⁴⁰Pu, ²⁴¹Pu, ²⁴²Pu, ²⁴³Pu or ²⁴⁴Pu, wherein nitrogen is enriched to at least 50% ¹⁵N, and wherein an atomic ratio of actinide nitride is between about 1:1 to 1:2.

In a further aspect of the present invention, the nuclear fuel comprises an actinide nitride for use in a liquid metal fast breeder or a molten salt fast breeder, comprising an actinide nitride, comprising a naturally occurring actinide or a synthetic element, the synthetic element having an atomic number greater than 92 or an atomic weight of 231 or greater, the actinide nitride selected from ²³³U, ²³⁵U, ²³⁶U, ³⁸U, ²³⁴U, ²³²Th, ²³⁹Pu, ²⁴⁰Pu, ²⁴¹Pu, ²⁴²Pu, ²⁴⁴Pu, ²³⁹Np, ²³⁹Am, ²⁴⁰Am, ²⁴¹Am, ²⁴²Am, ²⁴³Am, ²⁴⁴Am, ²⁴⁵Am, ²⁴⁰Cm, ²⁴¹Cm, ²⁴²Cm, ²⁴³Cm, ²⁴⁴Cm, ²⁴⁵Cm, ²⁴⁶Cm, ²⁴⁷Cm, ²⁴⁸Cm, ²⁴⁹Cm, ²⁵⁹Cm, ²⁴⁵Bk, ²⁴⁶Bk, ²⁴⁷Bk, ²⁴⁸Bk, ²⁴⁹Bk, ²⁵⁰Bk, ²⁴⁸Cf, ²⁴⁹Cf, ²⁵⁰Cf, ²⁵¹Cf, ²⁵²Cf, ²⁵³Cf, ²⁵⁴Cf, ²⁵⁵Cf, ²⁴⁹Es, ²⁵⁰Es, ²⁵¹Es, ²⁵²Es, ²⁵³Es, ²⁵⁴Es, ²⁵⁵Es, ²⁵¹Fm, ²⁵²Fm, ²⁵³Fm, ²⁵⁴Fm, ²⁵⁵Fm, ²⁵⁶Fm, ²⁵⁷Fm, ²⁵⁵Md, ²⁵⁶Md, ²⁵⁷Md, ²⁵⁸Md, ²⁵⁹Md, ²⁶⁰Md, ²⁵³No, ²⁵⁴No, ²⁵⁵No, ²⁵⁶No, ²⁵⁷No, ²⁵⁸No and ²⁵⁹No, wherein the nuclear fuel optionally includes fission products selected from the group consisting of ⁹⁷Tc, ⁹⁸Tc and ⁹⁹Tc, wherein nitrogen is enriched to at least 50% ¹⁵N, and wherein an atomic ratio of actinide nitride is between about 1:1 to 1:2.

A preferred actinide nitride is U¹⁵N.

The nuclear fuel of the present invention can be in particle, pellet or annular form. In addition, the nuclear fuel rods contained within the nuclear reactors can be configured in annular form so that water as a coolant can flow up the center of the fuel rod as well as along the sides of the fuel rods. The nuclear fuel also may be comprised of a burnable absorber.

It is an object of the present invention, therefore, to provide an economical fuel for use in nuclear reactors, including light and heavy water reactors, gas-cooled nuclear reactors, liquid metal fast breeders or molten salt fast breeders.

It is an additional object of the present invention to provide an actinide nitride fuel having enriched nitrogen-15, for use in light and heavy water reactors, gas-cooled nuclear reactors, liquid metal fast breeders or molten salt fast breeders.

It is a further object of the present invention to provide an economical fuel for use in light and heavy water reactors, gas-cooled nuclear reactors, liquid metal fast breeders or molten salt fast breeders, the fuel having the added benefit of reducing the volume of spent fuel discharged from the reactor.

These and other objects will become more readily apparent from the following detailed description and appended claims.

### DETAILED DESCRIPTION OF PREFERRED EMBODIMENTS

The present invention provides a cost-effective nuclear fuel for use in fission-based nuclear reactors.

In an embodiment of the present invention, there is provided a nuclear fuel comprised of an actinide nitride for use in a light water reactor, heavy water reactor or a high temperature gas cooled reactor such as a pebble bed modular reactor, comprising a naturally occurring actinide or a synthetic element, the synthetic element having an atomic number greater than 92 or an atomic weight of 231 or greater, the actinide nitride selected from ²³³U, ²³⁵U, ²³⁶U, ³⁸U, ²³²Th, ²³⁹Pu, ²⁴⁰Pu, ²⁴¹Pu, ²⁴²Pu, ²⁴³Pu or ²⁴⁴Pu, wherein nitrogen is enriched to at least 50% ¹⁵N, and wherein an atomic ratio of actinide nitride is between about 1:1 to 1:2.

In a further embodiment of the present invention, there is provided a nuclear fuel comprised of an actinide nitride for use in a liquid metal fast breeder or a molten salt fast breeder, comprising an actinide nitride, comprising a naturally occurring actinide or a synthetic element, the synthetic element having an atomic number greater than 92 or an atomic weight of 231 or greater, the actinide nitride selected from ²³³U, ²³⁴U, ²³⁵U, ²³⁶U, ²³⁸U, ²³²Th, ²³⁹Pu, ²⁴⁰Pu, ²⁴¹Pu, ²⁴²Pu, ²⁴⁴Pu, ²³⁹Np, ²³⁹Am, ²⁴⁰Am, ²⁴¹Am, ²⁴²Am, ²⁴³Am, ²⁴⁴Am, ²⁴⁵Am, ²⁴⁰Cm, ²⁴¹Cm, ²⁴²Cm, ²⁴³Cm, ²⁴⁴Cm, ²⁴⁵Cm, ²⁴⁶Cm, ²⁴⁷Cm, ²⁴⁸Cm, ²⁴⁹Cm, ²⁵⁹Cm, ²⁴⁵Bk, ²⁴⁶Bk, ²⁴⁷Bk, ²⁴⁸Bk, ²⁴⁹Bk, ²⁵⁰Bk, ²⁴⁸Cf, ²⁴⁹Cf, ²⁵⁰Cf, ²⁵¹Cf, ²⁵²Cf, ²⁵³Cf, ²⁵⁴Cf, ²⁵⁵Cf, ²⁴⁹Es, ²⁵⁰Es, ²⁵¹Es, ²⁵²Es, ²⁵³Es, ²⁵⁴Es, ²⁵⁵Es, ²⁵¹Fm, ²⁵²Fm, ²⁵³Fm, ²⁵⁴Fm, ²⁵⁵Fm, ²⁵⁶Fm, ²⁵⁷Fm, ²⁵⁵Md, ²⁵⁶Md, ²⁵⁷Md, ²⁵⁸Md, ²⁵⁹Md, ²⁶⁰Md, ²⁵³No, ²⁵⁴No, ²⁵⁵No, ²⁵⁶No, ²⁵⁷No, ²⁵⁸No and ²⁵⁹No, wherein the nuclear fuel optionally includes fission products selected from the group consisting of ⁹⁷Tc, ⁹⁸Tc and ⁹⁹Tc, wherein nitrogen is enriched to at least 50% ¹⁵N, and wherein an atomic ratio of actinide nitride is between about 1:1 to 1:2.

The use of an actinide nitride having enriched nitrogen provides a significant increase in fuel economy, as compared with UO₂ or UZrN fuels. A preferred actinide nitride is U¹⁵N.

The nuclear fuel of the present invention can be in particle, pellet or annular form. In addition, the nuclear fuel rods contained within the nuclear reactors can be configured in annular form so that water as a coolant can flow up the center of the fuel rod as well as along the sides of the fuel rods.

The following disclosure refers specifically to uranium nitride but also is descriptive of other actinide nitrides suitable for use in the present invention.

The stoichiometric ratio of uranium to nitrogen is preferably 1:1, but can range from between about 1:1 to about 1:2. Stoichiometric UN is preferred because it provides better corrosion resistance and minimal fission gas release.

As mentioned above, the use of U¹⁵N fuel provides significant fuel economy as compared to the use of natural N. As can be seen in Table 1, rods containing U¹⁵N fuel contain significantly more uranium per rod, up to 40% more as compared to UO₂ and UZr_{20%}N.

TABLE 1

| | Theoretical Pellet Stack | |
|---|---|---|
| Pellet | Uranium Density (gu/cc) | Kg U/rod |
| UO₂ | 9.7 | 1.86 |
| UZr_{20%}N | 11.8 | 2.06 |
| UN | 13.4 | 2.58 |

Additionally, U¹⁵N fuel has a lower parasitic cross-section, due to an order of magnitude lower neutron cross-section of ¹⁵N, as compared with oxygen. See, e.g., A. K. Petrov et al., J. Russ. Chem. Bull., 47:714 (1998); N. V. Chekalin et al., Phys. Lett., 59A:243 (1976); and N. V. Chekalin et al., Appl. Phys., 13:311 (1977). This results in the loss of fewer neutrons to parasitic reactions that do not result in fission. Below about 50% ¹⁵N enrichment, use of U¹⁵N fuel provides no benefit as compared with UO₂, due to the loss of neutrons to parasitic reactions with ¹⁴N. Thus, the optimum level of ¹⁵N is a trade-off between the cost of enrichment and the neutron penalty in the reactor. The increase in uranium density, in combination with longer fuel rods, can increase the uranium content of the core to an amount sufficient to reduce the feed and discharge batch size while preserving the desired fuel cycle, even for high power cores. In addition, the higher density can be used to increase fuel utilization and reduce fuel cost by reducing ²³⁵U enrichment requirements by about 0.1% to about 0.5% from current enrichment values, increase the discharge batch burnup, and/or reduce the number of new assemblies in each fuel reload, or a combination of all three.

The use of UN with enriched ¹⁵N has additional advantages. Radioactive carbon-14 is produced due to (n, p) reactions on nitrogen-14, the most common isotope of nitrogen, and is thus an undesirable by-product from use of UN fuels. The use of ¹⁵N reduces or eliminates this problem.

Uranium nitride fuel with natural nitrogen is used in fast breeder reactors. However, loss of neutrons due to reactions on nitrogen-14 makes the use of unenriched UN uneconomical in reactors based on thermal fission. Light and heavy water reactors run under less stringent conditions than fast breeder reactors (heat rates, neutron fluxes and temperatures), and the economy of neutrons is the foremost consideration. Table 2 provides a comparison of the economic benefits of U¹⁵N fuel having nitrogen enriched to 100% ¹⁵N, as compared with other fuel types.

TABLE 2

| | Feed Batch | Equivalent | Batch | | | | % Change |
|---|---|---|---|---|---|---|---|
| | Size | UO₂ Rod | Discharge | | | | in Total |
| Pellet | (Number of | Burnup Limit | Burnup | Relative Feed Cost | | | Fuel Cycle |
| Composition | Assemblies) | (GWD/MTU) | (GWD/MTU) | U Only | Total¹ | Total² | Cost |
| UO₂ | 96 | 60 | 48.6 | $43.5M | $57.6M | $56.7M | 5.71 m/kwhe |
| UZrN14 | 100 | 60 | 40.9 | +31.5% | +29.7% | +27.9% | +21.9% |
| UZrN15 | 96 | 60 | 42.6 | +0.7% | +2.6% | +0.5% | −0% |
| UZrN15 | 80 | 75 | 51.1 | −3.4% | −3.6% | −5.3% | −5.6% |
| UN15 | 96 | 60 | 34.1 | +0.2% | +6.6% | +0.4% | −0.2% |
| UN15 | 72 | 70 | 45.4 | −3.7% | −2.1% | −6.7% | −5.4% |
| UN15 | 68 | 75 | 48.1 | −3.7% | −3.0% | −7.1% | −7.2% |

Table 2 Notes:
¹When fabrication cost is $210/KgU
²When fabrication cost is $80K/assembly.
³Assuming 0.3 wt % tails, $12/lbU3O8 ore, $5.1/lbU conversion, $105/KgSWU enriching, $200K/assembly disposal

When referring to any numerical range of values herein, such ranges are understood to include each and every number and/or fraction between the stated range minimum and maximum. A range of at least about 50% ¹⁵N, for example, would expressly include all intermediate values of about 51%, 52%, 53%, 54% 55%, all the way up to and including 99%, 99.1%, 99.2%, up to and including 100% ¹⁵N.

Methods of isotopically enriching nitrogen are known in the art. For example, enriched nitrogen is a by-product of the manufacture of heavy water, in the form of NH₃. The level of ¹⁵N enrichment from this process can be on the order of several percent, and this can be further upgraded to produce the desired level of enrichment. Another method is laser isotope enrichment in infrared, using CH₃NO₂ and/or CH₃NH₂ as working molecules. Another possibility is the use of NH₃ as the working molecule in two-color laser isotope enrichment. Any of the above may be used alone or in combination, or in combination with other enrichment methods. Preferred is the use of the heavy water separation process to obtain the initial enriched ¹⁵NH₃, and then use of this as the working molecule for further enrichment with the laser isotope separation method. This method is the most cost effective, and has recently become feasible due to the development of improved laser isotope separation methods.

Methods of producing uranium nitride using unenriched nitrogen for use as a nuclear fuel also are known. See, e.g., U.S. Pat. Nos. 3,953,355; 3,953,556; 4,029,740; 4,231,976; 4,338,125; and 4624828, for various methods of producing UN. Any of these methods, or other methods known in the art, also can be used to make UN fuel using enriched nitrogen-15.

The U¹⁵N fuel of the present invention can be in various forms, including, but not limited to, pellet, annular, particle, or other shapes having improved surface to volume ratios as compared with pellets, such as four-leaf clovers. Pelleting methods known in the art can be used, and about 95% theoretical density can be achieved with U¹⁵N fuel.

The above described U¹⁵N fuel is suitable and economical for use in fast breeder reactors, as well as reactors that are substantially based on thermal fission such as light or heavy water nuclear reactors, including pressurized water reactors (PWR), boiling water reactors (BWR) and pressurized heavy water reactors (PHWR or CANDU), as well as gas-cooled reactors such as pebble bed reactors (PBMR) or prismatic reactors.

If desired, the U¹⁵N can be used in combination with a burnable absorber such as boron, cadmium, gadolinium, europium, and erbium or the like, as described in U.S. Pat. No. 5,147,598, to control initial excess reactivity in the core.

Whereas particular embodiments of this invention have been described above for purposes of illustration, it will be evident to those skilled in the art that numerous variations of the details of the present invention may be made without departing from the invention as defined in the appended claims.

What is claimed is:

1. A nuclear fuel for use in a fission based nuclear reactor comprising an actinide nitride, said actinide nitride comprising a naturally occurring actinide, or a synthetic element, the synthetic element having an atomic number greater than 92 or an atomic weight of 231 or greater, the actinide nitride selected from the group consisting of ²³³U, ²³⁴U, ²³⁵U, ²³⁶U, ²³⁸U, ²³²Th, ²³⁹Pu, ²⁴⁰Pu, ²⁴¹Pu, ²⁴²Pu, ²⁴³Pu, and ²⁴⁴Pu, wherein nitrogen is enriched to at least 50% ¹⁵N, and wherein an atomic ratio of actinide nitride is between about 1:1 to 1:2.

2. The nuclear fuel according to claim 1, wherein said fission-based nuclear reactor is selected from the group consisting of light water reactors, heavy water reactors and high temperature gas cooled reactors.

3. The nuclear fuel according to claim 2, wherein said high temperature gas cooled reactors are pebble bed modular reactors.

4. The nuclear fuel according to claim 1, wherein said actinide nitride is U¹⁵N.

5. The nuclear fuel of claim 1, wherein the nuclear fuel further comprises a burnable absorber.

6. The nuclear fuel of claim 1, wherein said fuel is in pellet form.

7. The nuclear fuel of claim 1, wherein said fuel is in annular form.

8. The nuclear fuel of claim 1, wherein said fuel is in particle form.

9. The nuclear fuel of claim 1, wherein said actinide nitride comprises nitrogen enriched to at least about 90% ¹⁵N.

10. The nuclear fuel of claim 1, wherein said actinide nitride comprises nitrogen enriched to at least about 95% ¹⁵N.

11. The nuclear fuel of claim 1, wherein said atomic ratio of actinide nitride is about 1:1.

12. A nuclear fuel for use in a fission based nuclear reactor comprising an actinide nitride, said actinide nitride comprising a naturally occurring actinide, or a synthetic element, the synthetic element having an atomic number greater than 92 or an atomic weight of 231 or greater, the actinide nitride selected from the group consisting of ²³³U, ²³⁴U, ²³⁵U, ²³⁶U, ²³⁸U, ²³²Th, ²³⁹Pu, ²⁴⁰Pu, ²⁴¹Pu, ²⁴²Pu, ²⁴⁴Pu, ²³⁹Np, ²³⁹Am, ²⁴⁰Am, ²⁴¹Am, ²⁴²Am, ²⁴³Am, ²⁴⁴Am, ²⁴⁵Am, ²⁴⁰Cm, ²⁴¹Cm, ²⁴²Cm, ²⁴³Cm, ²⁴⁴Cm, ²⁴⁵Cm, ²⁴⁶Cm, ²⁴⁷Cm, ²⁴⁸Cm, ²⁴⁹Cm, ²⁵⁹Cm, ²⁴⁵Bk, ²⁴⁶Bk, ²⁴⁷Bk, ²⁴⁸Bk, ²⁴⁹Bk, ²⁵⁰Bk, ²⁴⁸Cf, ²⁴⁹Cf, ²⁵⁰Cf, ²⁵¹Cf, ²⁵²Cf, ²⁵³Cf, ²⁵⁴Cf, ²⁵⁵Cf, ²⁴⁹Es, ²⁵⁰Es, ²⁵¹Es, ²⁵²Es, ²⁵³Es, ²⁵⁴Es, ²⁵⁵Es, ²⁵¹Fm, ²⁵²Fm, ²⁵³Fm, ²⁵⁴Fm, ²⁵⁵Fm, ²⁵⁶Fm, ²⁵⁷Fm, ²⁵⁵Md, ²⁵⁶Md, ²⁵⁷Md, ²⁵⁸Md, ²⁵⁹Md, ²⁶⁰Md, ²⁵³No, ²⁵⁴No, ²⁵⁵No, ²⁵⁶No, ²⁵⁷No, ²⁵⁸No and ²⁵⁹No, wherein the nuclear fuel optionally includes fission products selected from the group consisting of ⁹⁷Tc, ⁹⁸Tc and ⁹⁹Tc, wherein nitrogen is enriched to at least 50% ¹⁵N, and wherein an atomic ratio of actinide nitride is between about 1:1 to 1:2.

13. The nuclear fuel according to claim 12, wherein said fission-based nuclear reactor is selected from the group consisting of liquid metal fast breeders and molten salt fast breeders.

14. The nuclear fuel according to claim 12, wherein said actinide nitride is U¹⁵N.

15. The nuclear fuel of claim 12, wherein the nuclear fuel further comprises a burnable absorber.

16. The nuclear fuel of claim 12, wherein said fuel is in pellet form.

17. The nuclear fuel of claim 12, wherein said fuel is in annular form.

18. The nuclear fuel of claim 12, wherein said fuel is in particle form.

19. The nuclear fuel of claim 12, wherein said actinide nitride comprises nitrogen enriched to at least about 90% ¹⁵N.

20. The nuclear fuel of claim 12, wherein said actinide nitride comprises nitrogen enriched to at least about 95% ¹⁵N.

21. The nuclear fuel of claim 12, wherein said atomic ratio of actinide nitride is about 1:1.
